(19) United States
(12) Patent Application Publication
(10) Pub. No.: US 2011/0276177 A1
(43) Pub. Date: Nov. 10, 2011

(54) TERMINAL EQUIPMENT

(75) Inventor: Eiki Wakabayashi, Isesaki-shi (JP)

(73) Assignee: SANDEN CORPORATION, Isesaki-shi (JP)

(21) Appl. No.: 13/142,306

(22) PCT Filed: Jan. 6, 2010
(86) PCT No.: PCT/JP2010/000037

§ 371 Date: Jun. 27, 2011

(30) Foreign Application Priority Data
Jan. 13, 2009 (JP) 2009-4633

(51) Int. Cl. G06F 7/00

(52) U.S. Cl. 700/223

(57) ABSTRACT

To provide terminal equipment that can individually and easily set control contents of a currency identification device. Terminal equipment includes: a first connector for communicating with a currency identification device; and a storage unit that stores setting information for performing setting processing of the currency identification device, and the terminal equipment transmits the setting information stored in the storage unit to the currency identification device when communication can be performed with the currency identification device through the first connector. The terminal equipment includes a second connector for communicating with a predetermined information processing device; and a control unit that transmits the received setting information to the currency identification device when the setting information is received from the information processing device in a case where communication can be performed with the currency identification device and the information processing device through each of the first and second connectors.

### TECHNICAL FIELD

The present invention relates to terminal equipment for performing setting processing of a currency identification device provided in a settlement processing device, such as a vending machine.

### BACKGROUND ART

Conventionally, as this kind of terminal equipment, there has been known terminal equipment that includes: a first interface for communicating with a currency identification device; and a storage unit that stores setting information for performing setting processing of the currency identification device. And the terminal equipment transmits the setting information stored in the storage unit to the currency identification device when communication can be performed with the currency identification device through the first interface.

A simple structure is required for this terminal equipment in order that an operator can execute setting processing of the currency identification device easily and in a short time. For example, a button for instructing execution of setting processing is generally provided at this terminal equipment. When the button is pressed in a state where the terminal equipment and the currency identification device are connected to each other through the first interface, setting information stored in the storage unit is transmitted to the currency identification device. Meanwhile, when receiving the setting information, the currency identification device controls apparatuses therein based on the setting information. In a manner described above, the operator can easily execute setting processing of the currency identification device by performing a simple operation of connecting the terminal equipment and the currency identification device to each other to then press the button.

### PATENT LITERATURE 1: Japanese Patent Publication 2002-342811

### DISCLOSURE OF THE INVENTION

### Problems to be Solved by the Invention

By the way, when installing a vending machine in which this currency identification device is provided, it is necessary to improve operational flexibility by individually setting control contents of the currency identification device, for example, when the vending machine is installed at a location where change may be stolen, a remaining amount of change is set to be small, and when installed at a location with many sales opportunities of products, the remaining amount of change is set to be large.

However, in the above-described conventional example, the above-described remaining amount of change, etc. cannot be set individually since setting information in common with a plurality of currency identification devices is stored in the storage unit, and thus there has been a possibility of poor operational flexibility.

The present invention is made in view of the above-described situation, and an object thereof is to provide terminal equipment that can individually and easily set control contents of a currency identification device.

### Means for Solving the Problems

In order to achieve the above-described object, terminal equipment according to the present invention comprises: a first interface for communicating with a currency identification device; and a storage unit for storing setting information for performing setting processing of the currency identification device, and the terminal equipment transmits the setting information stored in the storage unit to the currency identification device when communication can be performed with the currency identification device through the first interface. The terminal equipment further comprises: a second interface for communicating with a predetermined information processing device; and a control unit for transmitting received setting information to the currency identification device when receiving the setting information from the information processing device in a case where communication can be performed with the currency identification device and the information processing device through each of the first and second interfaces.

As a result of this, since setting information received from the information processing device is transmitted to the currency identification device when communication can be performed with the currency identification device and the information processing device through each of the first and second interfaces, for example, when setting information for every currency identification device is generated by the information processing device, it becomes possible to perform individual setting of the currency identification device by a simple operation of connecting the terminal equipment to the currency identification device and the information processing device, respectively.

### Advantages of the Invention

As explained above, according to the present invention, for example, when setting information for every currency identification device is generated by the information processing device, individual setting of the currency identification device can be performed by the simple operation of connecting the terminal equipment to the currency identification device and the information processing device, respectively, and therefore, control contents of the currency identification device can be individually and easily set, thus enabling to improve operational flexibility.

### BRIEF DESCRIPTION OF THE DRAWINGS

FIG. 1 is a schematic structure view of a currency identification device that is set by terminal equipment showing one embodiment of the present invention.

FIG. 2 is an external perspective view of the terminal equipment.

FIG. 3 is a functional block diagram of the currency identification device and a control device.

FIG. 4 is a sequence diagram showing operations of the terminal equipment at the time of obtaining setting information from an information processing device.

FIG. 5 is a sequence diagram showing operations of the terminal equipment at the time of transmitting the setting information to the currency identification device.

FIG. 6 is a sequence diagram showing operations of the terminal equipment at the time of performing individual setting of the currency identification device.

### BEST MODE FOR CARRYING OUT THE INVENTION

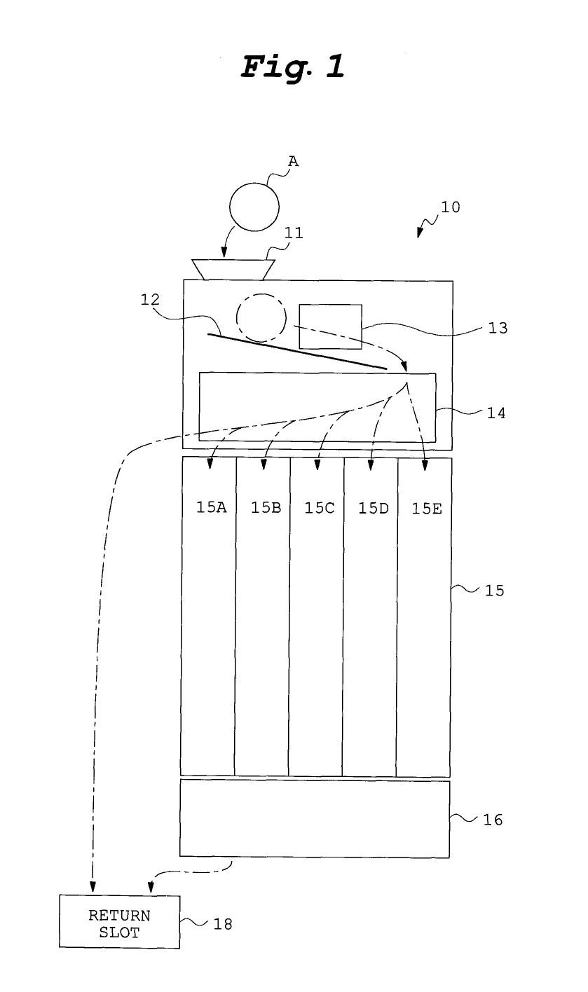

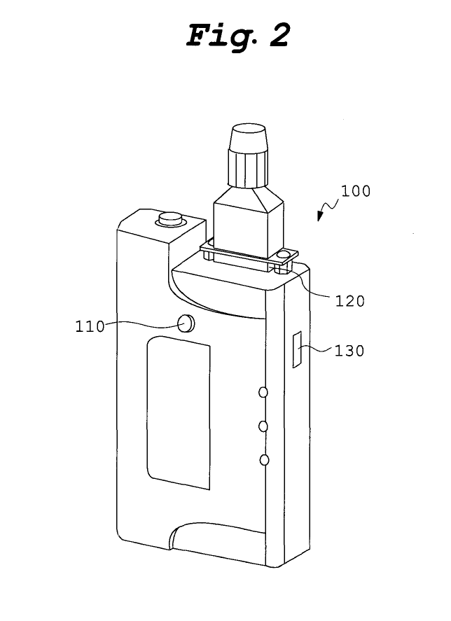

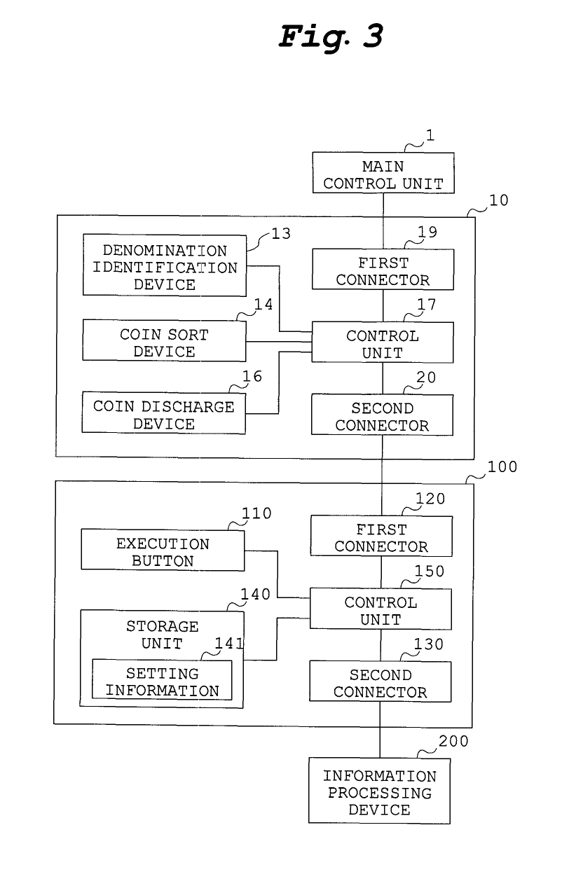

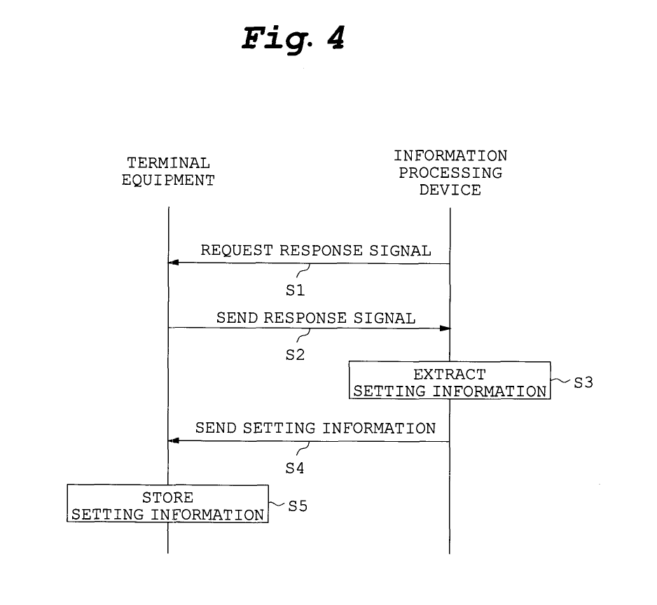

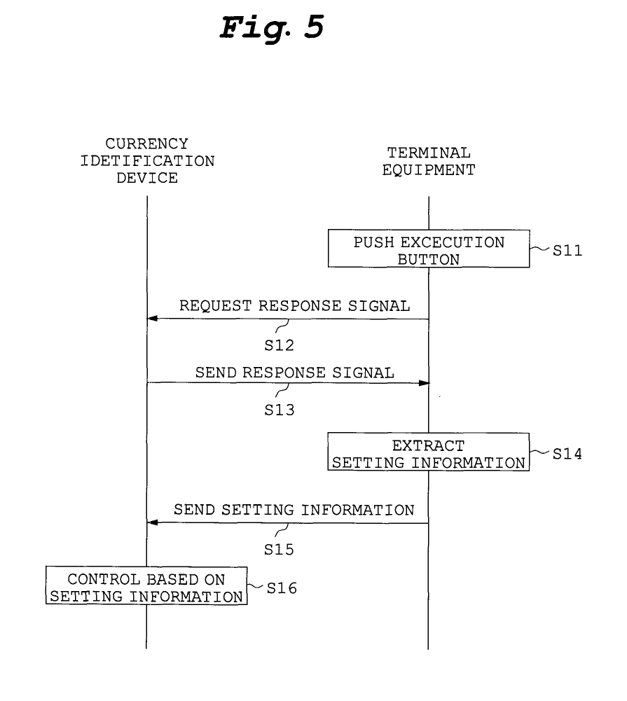

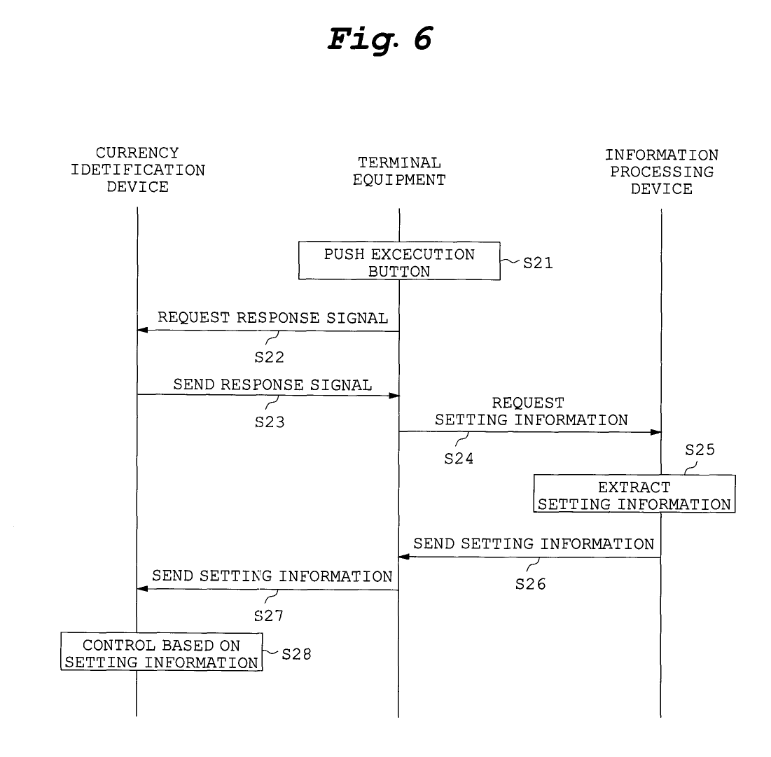

FIGS. 1 to 6 show one embodiment of the present invention, and FIG. 1 is a schematic structure view of a currency identification device that is set by terminal equipment, FIG. 2 is an external perspective view of the terminal equipment, FIG. 3 is a functional block diagram of the currency identification device and a control device, FIG. 4 is a sequence diagram showing operations of the terminal equipment at the time of obtaining setting information from an information processing device, FIG. 5 is a sequence diagram showing operations of the terminal equipment at the time of transmitting the setting information to the currency identification device, and FIG. 6 is a sequence diagram showing operations of the terminal equipment at the time of performing individual setting of the currency identification device.

Terminal equipment 100 of the present invention is the equipment configured to be able to transmit setting information 141 for performing setting processing of a currency identification device 10 when communication can be performed with the currency identification device 10. In addition, the terminal equipment 100 is configured to communicate with a predetermined information processing device 200 to thereby be able to receive the setting information 141 from the information processing device 200.

First, there will be described a schematic structure of the currency identification device 10 that is set by the terminal equipment 100 with reference to FIG. 1. The currency identification device 10 is provided in a vending machine etc. that perform settlement processing using cash. As shown in FIG. 1, the currency identification device 10 includes: a slot 11 for a coin A as a currency; a coin guide path 12 through which the coin A inserted from the slot 11 is guided; a denomination identification device 13 that determines authenticity and a denomination of the coin A passing through the coin guide path 12; a coin sort device 14 that sorts the coin A having passed through the coin guide path 12 into a returning-side path or each path for every accepted denomination; a coin storage cylinder 15 as a currency storage for storing the coin A sorted by the coin sort device 14; a coin discharge device 16 that discharges the coin A stored in the coin storage cylinder 15; a control unit 17; a first connector 19; and a second connector 20 (the control unit 17, the first connector 19, and the second connector 20 are not shown in FIG. 1). It is to be noted that since structures of the slot 11, the coin guide path 12, the denomination identification device 13, the coin sort device 14, the coin storage cylinder 15, and the coin discharge device 16 are similar to those of a conventional currency identification device, a detailed description thereof are omitted herein.

The coin storage cylinder 15 is comprised of a plurality of tubes 15A to 15E formed for every denomination. The coin sort device 14 operates based on an instruction from the control unit 17, and sorts the inserted coin A into the respective tubes 15A to 15E of the coin storage cylinder 15, and also sorts the inserted coin A into a predetermined return slot 18 or a safe (not shown) if needed. In addition, structures of the control unit 17, the first connector 19, and the second connector 20 will be described hereinafter.

Next, a schematic structure of the terminal equipment 100 will be described with reference to FIG. 2. The terminal equipment 100 of the embodiment is the portable terminal equipment with which data communication can be performed using a wired connection with the currency identification device 10 and the information processing device 200, respectively. As shown in FIG. 2, the terminal equipment 100 includes: an execution button 110 as an information input unit for executing transmission processing of the setting information 141; a first connector 120 as a first interface for communicating with the currency identification device 10; and a second connector 130 as a second interface for communicating with the information processing device 200. Here, the first connector 120 is the connector complying with RS-232C standard, and the second connector 130 is the connector complying with USB standard. In addition, the terminal equipment 100 includes a storage unit 140 and a control unit 150 although they are not shown here.

Next, there will be described control system structures of the currency identification device 10, the terminal equipment 100, and the information processing device 200 with reference to the functional block diagram of FIG. 3.

First, the control system structure of the currency identification device 10 will be described. The control unit 17 is comprised of a computer including a CPU, a RAM, a ROM, etc., and controls the whole currency identification device 10. In addition, the control unit 17 is configured to be able to calculate the number of stored coins in the respective tubes 15A to 15E based on the number of sorted coins A into the respective tubes 15A to 15E by the coin sort device 14, and the number of discharged coins A from the respective tubes 15A to 15E by the coin discharge device 16. Here, the number of stored coins in the respective tubes 15A to 15E can be changed based on the setting information 141, which will be described hereinafter. The first connector 19 is the connector complying with JVMA (Japan Vending Machine Manufacturers Association) interface specification, and it is the connector for communicating with a main control unit 1 etc. provided in the vending machine. In addition, the second connector 20 is the connector complying with RS-232C standard, and it is the connector for communicating with the terminal equipment 100.

Subsequently, the control system structure of the terminal equipment 100 will be described. The storage unit 140 is a rewritable storage element, such as an EEPROM etc., in which the setting information 141 for performing setting processing of the currency identification device 10 is stored. The setting information 141 is stored in a state of being corresponding to a currency identification device ID (not shown) for identifying the currency identification device 10 and a terminal equipment ID (not shown) for identifying the terminal equipment 100, respectively. In addition, at least the number of coins A that can be stored in the respective tubes 15A to 15E of the currency identification device 10 is included in the setting information 141.

The control unit 150 is comprised of a computer including a CPU, a RAM, a ROM, etc., and controls the whole terminal equipment 100. It is to be noted that details of operations of the control unit 150 will be described hereinafter.

Next, the information processing device 200 will be described. The information processing device 200 is a well-known personal computer, and it is configured to be able to communicate with the terminal equipment 100. In addition, the information processing device 200 is configured to be able to generate/change the setting information 141 using a GUI, and the generated/changed setting information 141 is stored in a predetermined storage device (not shown).

Hereinafter, there will be described operations at the time of obtaining the setting information 141 from the information processing device 200 in the terminal equipment 100 according to the embodiment with reference to the sequence diagram of FIG. 4.

First, in a state where the terminal equipment 100 is connected communicatively with the information processing device 200 through the second connector 130, the information processing device 200 transmits a predetermined response signal request command to the terminal equipment 100 (step S1). Meanwhile, when receiving the response signal request command through the second connector 130, the control unit 150 of the terminal equipment 100 transmits a response signal with respect to the command to the information processing device 200 through the second connector 130 (step S2). In this case, the terminal equipment ID is included in the response signal.

Subsequently, when receiving the response signal, the information processing device 200 extracts from the storage device (not shown) the setting information 141 corresponding to the terminal equipment ID included in the response signal (step S3), and transmits the extracted setting information 141 to the terminal equipment 100 (step S4). Meanwhile, when receiving the setting information 141, the control unit 150 of the terminal equipment 100 stores the setting information 141 in the storage unit 140.

Next, there will be described operations of the terminal equipment 100 at the time of transmitting the setting information 141 to the currency identification device 10 with reference to the sequence diagram of FIG. 5.

First, when the execution button 110 is pressed in the state where the terminal equipment 100 is connected communicatively with the currency identification device 10 through the first connector 120 (step S11), the control unit 150 of the terminal equipment 100 transmits a predetermined response signal request command to the currency identification device 10 (step S12). Meanwhile, when receiving the response signal request command through the second connector 20, the control unit 17 of the currency identification device 10 transmits a response signal with respect to the command to the terminal equipment 100 through the second connector 20 (step S13). In this case, the currency identification device ID is included in the response signal.

Subsequently, when receiving the response signal, the control unit 150 of the terminal equipment 100 extracts from the storage unit 140 the setting information 141 corresponding to the currency identification device ID included in the response signal (step S14), and transmits the extracted setting information 141 to the currency identification device 10 (step S15). Meanwhile, when receiving the setting information 141, the control unit 17 of the currency identification device 10 controls each apparatus in the currency identification device 10 based on the setting information 141 (step S16). In this case, the control unit 17 of the currency identification device 10 can change the number of stored coins in the respective tubes 15A to 15E by controlling the coin sort device 14 and the coin discharge device 16 based on the number of stored coins in the respective tubes 15A to 15E included in the setting information 141.

In a manner described above, the execution button 110 is pressed in the state where the terminal equipment 100 is connected communicatively with the currency identification device 10 through the first connector 120, thereby enabling to easily set the currency identification device 10.

Next, there will be described operations of the terminal equipment 100 at the time of performing individual setting of the currency identification device 10 with reference to the sequence diagram of FIG. 6.

First, when the execution button 110 is pressed in a state where the terminal equipment 100 is connected communicatively with the currency identification device 10 and the information processing device 200, respectively through the first and second connectors 120 and 130 (step S21), the control unit 150 of the terminal equipment 100 transmits a predetermined response signal request command to the currency identification device 10 (step S22). Meanwhile, when receiving the response signal request command through the second connector 20, the control unit 17 of the currency identification device 10 transmits a response signal with respect to the command to the terminal equipment 100 through the second connector 20 (step S23). In this case, the currency identification device ID is included in the response signal.

Subsequently, when receiving the response signal, the control unit 150 of the terminal equipment 100 transmits to the information processing device a command to request transmission of the setting information 141 corresponding to the currency identification device ID included in the response signal through the second connector 130 (step S24). Meanwhile, when receiving the command, the information processing device 200 extracts from the storage device the setting information 141 corresponding to the currency identification device ID (step S25), and transmits the extracted setting information 141 to the terminal equipment 100 (step S26). In addition, the control unit 150 of the terminal equipment 100 transmits the received setting information 141 to the currency identification device 10 (step S27). Subsequently, the control unit 17 of the currency identification device 10 controls the each apparatus in the currency identification device 10 based on the setting information 141 (step S28).

As a result of this, since the setting information 141 received from the information processing device 200 is transmitted to the currency identification device 10 when communication can be performed with the currency identification device 10 and the information processing device 200 through each of the first and second connectors 120 and 130, it becomes possible to perform individual setting of the currency identification device 10 by a simple operation of connecting the terminal equipment 100 to the currency identification device 10 and the information processing device 200, respectively. In addition, since at least the number of coins A that can be stored in the coin storage cylinder 15 of the currency identification device 10 is included in the setting information 141 of the embodiment, it becomes possible to individually set control contents, for example, when a vending machine or the like is installed at a location where change may be stolen, a remaining amount of the stored coins A is set to be small, and when installed at a location with many sales opportunities of products, the remaining amount of the stored coins A is set to be large.

As described above, with the terminal equipment 100 according to the embodiment, individual setting of the currency identification device 10 can be performed by the simple operation of connecting the terminal equipment 100 to the currency identification device 10 and the information processing device 200, respectively, and therefore, control contents of the currency identification device 10 can be individually and easily set, thus enabling to improve operational flexibility.

In addition, since the control unit 150 transmits the setting information 141 stored in the storage unit 140 to the currency identification device 10 when the execution button 110 is pressed in a case where the terminal equipment 100 includes the execution button 110, and communication can be performed with the currency identification device 10 through the first connector 120, the plurality of currency identification devices 10 are made to perform control based on the setting information 141 stored in the storage unit 140, thus enabling to easily perform setting processing in common with the each currency identification device 10.

Further, since at least the number of coins A that can be stored in the coin storage cylinder 15 provided in the currency identification device 10 is included in the setting information 141, control contents can be individually set, for example, when the vending machine or the like is installed at a location where change may be stolen, a remaining amount of the stored coins A is set to be small, and when installed at a location with many sales opportunities of products, the remaining amount of the stored coins A is set to be large, thus enabling to improve operational flexibility.

It is to be noted that the above-described embodiment is only a specific example of the present invention, and the present invention is not limited only to the above-described embodiment. For example, although only the coin A has been dealt with in the above-described embodiment, the present invention may also be configured to be able to deal with bills.

In addition, although the present invention is configured so that the setting information 141 may be transmitted to the currency identification device 10 when the execution button 110 is pressed in the above-described embodiment, it may be configured so that the setting information 141 may be transmitted to the currency identification device 10 when a predetermined number string is input using a numeric keypad provided at the terminal equipment 100.

Further, although the terminal equipment 100 is configured to be able to communicate with the currency identification device 10 and the information processing device 200, respectively using the wired connection in the above-described embodiment, it may be configured to be able to perform wireless communication using an infrared ray etc. with the currency identification device 10 and the information processing device 200, respectively.

### INDUSTRIAL APPLICABILITY

Since individual setting of a currency identification device can be performed by a simple operation of connecting terminal equipment to the currency identification device and an information processing device, respectively when setting information for every currency identification device is generated by the information processing device, the present invention is suitable for a currency identification device in which control contents can be set individually and easily.

### DESCRIPTION OF SYMBOLS

10 . . . Currency identification device, 15 . . . Currency storage, 100 . . . Terminal equipment, 110 . . . Execution button, 120 . . . First connector, 130 . . . Second connector, 140 . . . Storage unit, 141 . . . Setting information, 150 . . . Control unit, 200 . . . Information processing device, A . . . Coin

1. Terminal equipment, comprising: a first interface for communicating with a currency identification device; and a storage unit for storing setting information for performing setting processing of the currency identification device, and the terminal equipment transmits the setting information stored in the storage unit to the currency identification device when communication can be performed with the currency identification device through the first interface, wherein the terminal equipment further comprises:
a second interface for communicating with a predetermined information processing device; and
a control unit for transmitting received setting information to the currency identification device when receiving the setting information from the information processing device in a case where communication can be performed with the currency identification device and the information processing device through each of the first and second interfaces.

2. The terminal equipment according to claim 1, comprising an information input unit, wherein
the control unit transmits the setting information stored in the storage unit to the currency identification device when predetermined information is input using the information input unit in a case where communication can be performed with the currency identification device through the first interface.

3. The terminal equipment according to claim 1, wherein
the setting information includes at least the number of currencies that can be stored in a currency storage provided in the currency identification device.
